(19) United States
(12) Patent Application Publication
(10) Pub. No.: US 2005/0108698 A1
(43) Pub. Date: May 19, 2005

(54) Assembler capable of reducing size of object code, and processor for executing the object code

(75) Inventors: Junko Kobara, Hyogo (JP); Hiroyuki Kawai, Hyogo (JP); Hiroyuki Morinaka, Hyogo (JP); Yoshitsugu Inoue, Hyogo (JP)

Correspondence Address: McDermott, Will & Emery, 600 13th Street, N.W., Washington, DC, 20005-3096, US

(73) Assignee: RENESAS TECHNOLOGY CORP.

(21) Appl. No.: 10/841,467

(22) Filed: May 10, 2004

(30) Foreign Application Priority Data
Nov. 18, 2003 (JP) 2003-388130(P)

(51) Int. Cl. G06F 9/45

(52) U.S. Cl. 717/154

(57) ABSTRACT

An instruction analyzing unit sequentially analyzes instructions of a program which is inputted to a program inputting unit. A NOP instruction analyzing part encodes continuous NOP instructions as one continuous NOP instruction. An instruction code outputting unit outputs the instruction encoded by the instruction analyzing unit as an object code. Therefore, the size of the object code can be reduced.

### BACKGROUND OF THE INVENTION

1. Field of the Invention

The present invention relates to an assembler for converting a program described in a mnemonic code into an object code of a machine language and a processor for executing the object code and, more particularly, to an assembler capable of reducing the size of an object code and a processor for executing the object code.

2. Description of the Background Art

In a program control type processor core, in the case where a plurality of cycles are necessary to complete execution of instructions such as a load instruction, a branch instruction and an operation instruction, wait time occurs. In order to execute an instruction of using results of the instructions, it is necessary to insert a NOP instruction to guarantee accurate execution of a program. Related techniques include the inventions disclosed in Japanese Patent Laying-Open Nos. 4-275603 and 2-12429.

In a programmable controller disclosed in Japanese Patent Laying-Open No. 4-275603, data N indicative of the number of NOP execution times added to a NOP instruction is set to a built-in subtraction counter and a program counter is stopped. The subtraction counter is decremented at every processing timing and, when the decremented count value becomes “1”, counting of the program counter is restarted.

In an information processor with a delayed jump matching function disclosed in Japanese Patent Laying-Open No. 2-12429, when a jump instruction or a conditional jump instruction is executed in a “NOP insertion mode”, a jump instruction detection signal becomes true. If a mode bit indicates the “NOP insertion mode” at this time, an input of an instruction register is switched from an instruction buffer to a NOP code generating circuit. To an input of the program counter, not an output of a normal incrementer but a present value of the program counter is fed back. Consequently, at the following clock, therefore, not a prefetched instruction but a NOP code from the NOP code generating circuit is loaded to the instruction register.

The programmable controller disclosed in Japanese Patent Laying-Open No. 4-275603 executes a NOP instruction in accordance with the data N indicative of the number of NOP execution times added to the NOP instruction. Generally, a continuous NOP instruction (instruction for executing NOP continuously) immediately after the branch instruction is often inserted to prevent a resource conflict caused by an instruction given immediately after the continuous NOP instruction. Therefore, when the continuous NOP instruction is executed in the case where a branch condition of the branch instruction is satisfied, an unnecessary NOP is executed, and it causes a problem of deterioration in performance.

In the information processor with the delayed jump matching function disclosed in Japanese Patent Laying-Open No. 2-12429, when a jump instruction or a conditional jump instruction is executed in the “NOP insertion mode”, updating of the program counter is stopped. Consequently, there is a problem in that an unnecessary NOP instruction is automatically inserted also in the case where the branching condition is not satisfied.

### SUMMARY OF THE INVENTION

An object of the present invention is to provide an assembler capable of reducing the size of an object code.

Another object of the present invention is to provide a processor in which an unnecessary NOP instruction is prevented from being inserted.

According to an aspect of the present invention, an assembler includes an instruction analyzing unit sequentially analyzing instructions of an inputted program and encoding a plurality of continuous no-operation instructions as a continuous no-operation instruction having an operand designating the number of the plurality of no-operation instructions, and an outputting unit outputting the instruction encoded by the instruction analyzing unit as an object code.

Since the instruction analyzing unit sequentially analyzes instructions of an inputted program and encodes continuous no-operation instructions as one continuous no-operation instruction, the size of the object code can be reduced.

According to another aspect of the present invention, a processor includes an address generating unit generating an address of an instruction to be fetched, an instruction fetching unit fetching an instruction in accordance with the address generated by the address generating unit, an instruction decoding unit decoding the instruction fetched by the instruction fetching unit, and an instruction executing unit executing the instruction in accordance with a result of decoding of the instruction decoding unit. When an instruction to be decoded is a continuous no-operation instruction having an operand designation field, the instruction decoding unit can process the instruction as continuous no-operation instructions of the number corresponding to the number designated in the operand designation field. When the instruction fetched immediately before the continuous no-operation instruction is a branch instruction and branch is performed by the branch instruction, the instruction decoding unit processes the instruction as no-operation instructions of the number which does not depend on the operand designation field.

When a decoded instruction is a continuous no operation instruction, in the case where the instruction fetched immediately before the continuous no-operation instruction is a branch instruction and a branch condition is satisfied, the instruction decoding unit processes the continuous no-operation instruction as a normal no-operation instruction. Consequently, insertion of an unnecessary no-operation instruction can be prevented.

According to still another aspect of the present invention, a processor includes an address generating unit generating an address of an instruction to be fetched, an instruction fetching unit fetching an instruction in accordance with the address generated by the address generating unit, an instruction decoding unit decoding the instruction fetched by the instruction fetching unit, and an instruction executing unit executing the instruction in accordance with a result of decoding of the instruction decoding unit. When the decoded instruction is a branch instruction with no operation and a branch condition is satisfied, the instruction decoding unit inserts a no-operation instruction after the branch instruction with no-operation. When the decoded instruction is a branch instruction with no operation and a branch condition is not satisfied, the instruction decoding unit does not insert a no-operation instruction.

When the decoded instruction is a branch instruction with no operation and a branch condition is satisfied, the instruction decoding unit inserts a no-operation instruction. When the decoded instruction is a branch instruction with no operation and a branch condition is not satisfied, the instruction decoding unit does not insert a no-operation instruction. Thus, insertion of an unnecessary no-operation instruction can be prevented.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a functional configuration of a general assembler;

FIGS. 2A and 2B are diagrams showing an example of a program to be inputted to the assembler shown in FIG. 1 and generated object codes;

FIG. 3 is a block diagram showing a configuration example of an assembler in a first embodiment of the present invention;

FIG. 4 is a block diagram showing a functional configuration of the assembler in the first embodiment of the present invention;

FIG. 5 is a flowchart for describing a procedure of the assembler in the first embodiment of the present invention;

FIGS. 6A and 6B are diagrams showing an example of a program to be inputted to a program inputting unit 12 and generated object codes;

FIG. 7 is a diagram showing an example of an instruction code in the first embodiment of the present invention;

FIGS. 8A and 8B are diagrams showing an example of a program including a labeled NOP instruction and a NOP instruction with an argument, which is to be assembled by the assembler in the first embodiment of the present invention, and object codes of the program;

FIG. 9 is a flowchart for describing a procedure of an assembler in a second embodiment of the present invention;

FIGS. 10A and 10B are diagrams showing an example of a program including a labeled NOP instruction and a NOP instruction with an argument, which is to be assembled by the assembler in the second embodiment of the present invention, and object codes of the program;

FIG. 11 is a block diagram showing a schematic configuration of a processor in a third embodiment of the present invention;

FIG. 12 is a block diagram for more specifically describing an instruction decoding unit 32 shown in FIG. 11;

FIGS. 13A and 13B are diagrams showing an example of a program to be executed by the processor in the third embodiment of the present invention, and a timing chart;

FIGS. 14A to 14C are diagrams showing a program including a conditional branch instruction JACCN with NOP executed by the processor in the third embodiment of the present invention, and a pipeline process;

FIGS. 15A to 15C are diagrams for describing processes of a processor in a fourth embodiment of the present invention;

FIG. 16 is a diagram for describing kinds of branch instructions with NOP;

FIG. 17 is a block diagram showing the configuration of an instruction decoding unit 52 in the fourth embodiment of the present invention;

FIGS. 18A and 18B are diagrams showing an example of a program executed by the processor in the fourth embodiment of the present invention, and a timing chart;

FIGS. 19A to 19C are diagrams showing an example of a program including a conditional branch instruction JACC executed by the processor in the fourth embodiment of the present invention, and a pipeline process;

FIG. 20 is a block diagram showing the configuration of an instruction fetching unit in a fifth embodiment of the present invention;

FIGS. 21A and 21B are diagrams showing an example of a program executed by the processor in the fifth embodiment of the present invention, and a timing chart;

FIG. 22 is a block diagram for describing the details of an instruction decoding unit 62 in a sixth embodiment of the present invention; and

FIGS. 23A and 23B are diagrams showing an example of a program executed by a processor in the sixth embodiment of the present invention, and a timing chart.

### DESCRIPTION OF THE PREFERRED EMBODIMENTS

### First Embodiment

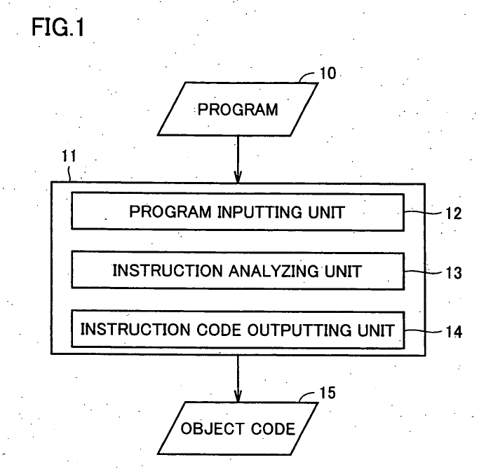

First, an operation of a general assembler will be described. FIG. 1 is a block diagram showing a functional configuration of a general assembler. An assembler 111 includes a program inputting unit 12 to which a program 10 described in a mnemonic code is inputted, an instruction analyzing unit 13 for analyzing instruction codes of the program inputted to the program inputting unit 12 one by one and outputting an encoded instruction, and an instruction code outputting unit 14 for outputting the encoded instruction which is outputted from instruction analyzing unit 13 as an object code 15.

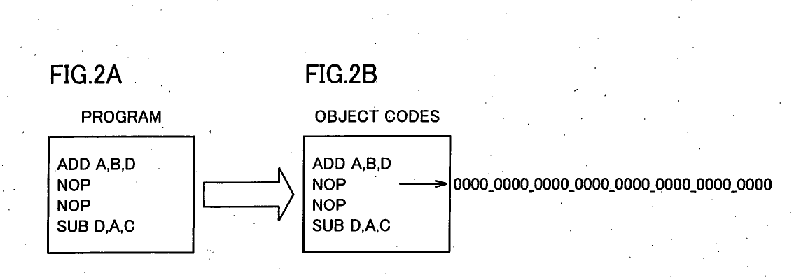

FIGS. 2A and 2B are diagrams showing an example of a program which is inputted to the assembler shown in FIG. 1, and generated object codes. When the program shown in FIG. 2A is inputted to program inputting unit 12, instruction analyzing unit 13 analyzes instructions of the program shown in FIG. 2A one by one and outputs encoded instructions. As a result, instruction code outputting unit 14 outputs object codes 15 as shown in FIG. 2B. As shown in FIG. 2B, each of NOP instructions is encoded as it is and converted to a machine language. One instruction code consists of 32 bits. ADD denotes an addition instruction, and SUB indicates a subtraction instruction.

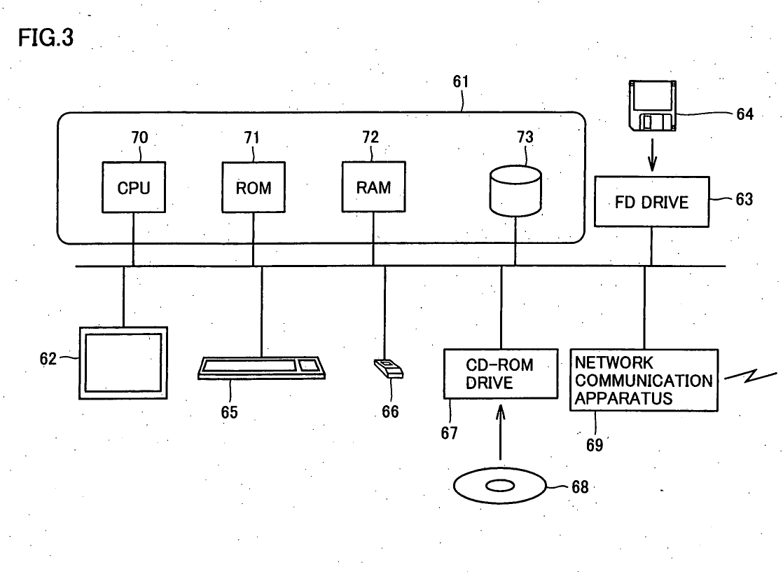

FIG. 3 is a block diagram showing a configuration example of the assembler in the first embodiment of the present invention. The assembler includes a computer body 61, a display device 62, an FD drive 63 into which an FD (Flexible Disk) 64 is loaded, a keyboard 65, a mouse 66, a CD-ROM drive 67 into which a CD-ROM (Compact Disc-Read Only Memory) 68 is inserted, and a network communication apparatus 69.

An assembly program is supplied by a recording medium such as FD 64 or CD-ROM 68. When the assembly program is executed by computer body 61, an object code is generated from the program described in the mnemonic code. Alternatively, the assembly program may be supplied from another computer to computer body 61 via network communication apparatus 69.

Computer body 61 shown in FIG. 3 includes a CPU (Central Processing Unit) 70, a ROM (Read Only Memory) 71, a RAM (Random Access Memory) 72, and a hard disk 73. CPU 70 performs a process while inputting/outputting data from/to display device 62, FD drive 63, keyboard 65, mouse 66, CD-ROM drive 67, network communication apparatus 69, ROM 71, RAM 72 or hard disk 73.

The assembly program recorded on FD 64 or CD-ROM 68 is stored into hard disk 73 via FD drive 63 or CD-ROM drive 67 by CPU 70. CPU 70 properly loads the assembly program from hard disk 73 into RAM 72 and executes it, thereby generating an object code from the program described in the mnemonic code.

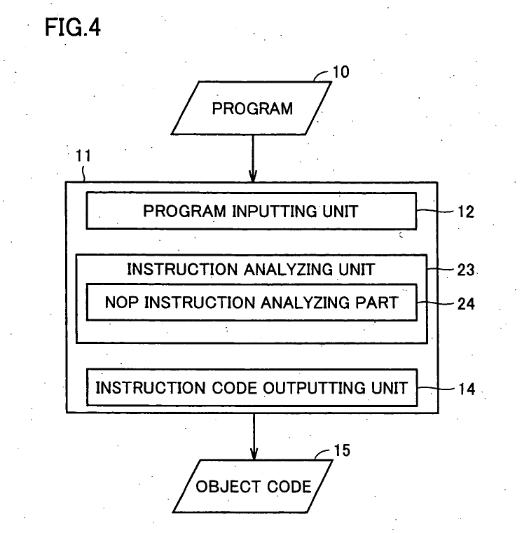

FIG. 4 is a block diagram showing a functional configuration of the assembler in the first embodiment of the present invention. The assembler is similar to the assembler shown in FIG. 1 except for the configuration and function of an instruction analyzing unit 23. Instruction analyzing unit 23 includes a NOP instruction analyzing part 24 for analyzing a NOP instruction in the case where an instruction code indicates the NOP instruction.

FIG. 5 is a flowchart for describing a procedure of the assembler in the first embodiment of the present invention. First, instruction analyzing unit 23 determines whether processing on a final instruction held in program inputting unit 12 has been finished or not (S1). If the processing on the final instruction code has not been finished yet (No in S1), instruction analyzing unit 23 extracts one instruction and determines whether the instruction is a NOP instruction or not (S2).

If the instruction is a NOP instruction (Yes in S2), NOP instruction analyzing part 24 determines that the NOP instruction is a labeled NOP instruction or a NOP instruction with an argument (S3). The NOP instruction with an argument refers to an instruction described as NOP<n> (<n> denotes an integer of 1 or more). <n> expresses the number of processing times of the NOP instruction. Usually, in the case of executing the NOP instruction only once, it is sufficient to use a NOP instruction without an argument. When it is not desired that continuous NOP instructions are combined into one instruction, “NOP 1” is designated explicitly.

Also in the labeled NOP instruction, in the case where the label is designated as a branch destination address by a branch instruction, the instruction is prevented from being combined with the preceding and subsequent NOP instructions into one instruction.

If the NOP instruction is a labeled NOP instruction or a NOP instruction with an argument (Yes in S3), NOP instruction analyzing part 24 determines whether a NOP flag is set or not (S4). If a NOP flag is set (Yes in S4), NOP instruction analyzing part 24 encodes the NOP instruction with an argument using the value of the counter as an argument, and resets the NOP flag and the counter (S5). Instruction analyzing unit 23 encodes a target instruction (S6), returns to step S1, and repeats the following processes.

In the case where the NOP instruction is neither a labeled NOP instruction nor a NOP instruction with an argument (No in S3), NOP instruction analyzing part 24 determines whether the NOP flag is set or not (S7). If the NOP flag is set (Yes in S7), NOP instruction analyzing part 24 increments the value of the counter (S8), returns step S1, and repeats the following processes.

If the NOP flag is not set (No in S7), NOP instruction analyzing part 24 sets the NOP flag, resets the counter (S9), returns to step S1, and repeats the following processes.

In the case where instruction analyzing unit 23 determines that processing on the final instruction is finished in step S1 (Yes in S1), it is determined whether the NOP flag is set or not (S10). If the NOP flag is set (Yes in S1), NOP instruction analyzing part 24 encodes the continuous NOP instruction using the value of the counter as an argument (S11) and finishes the process. If a NOP flag is not set (No in S10), the processing is finished as it is. Object code 15 generated by the processing is outputted from instruction code outputting unit 14.

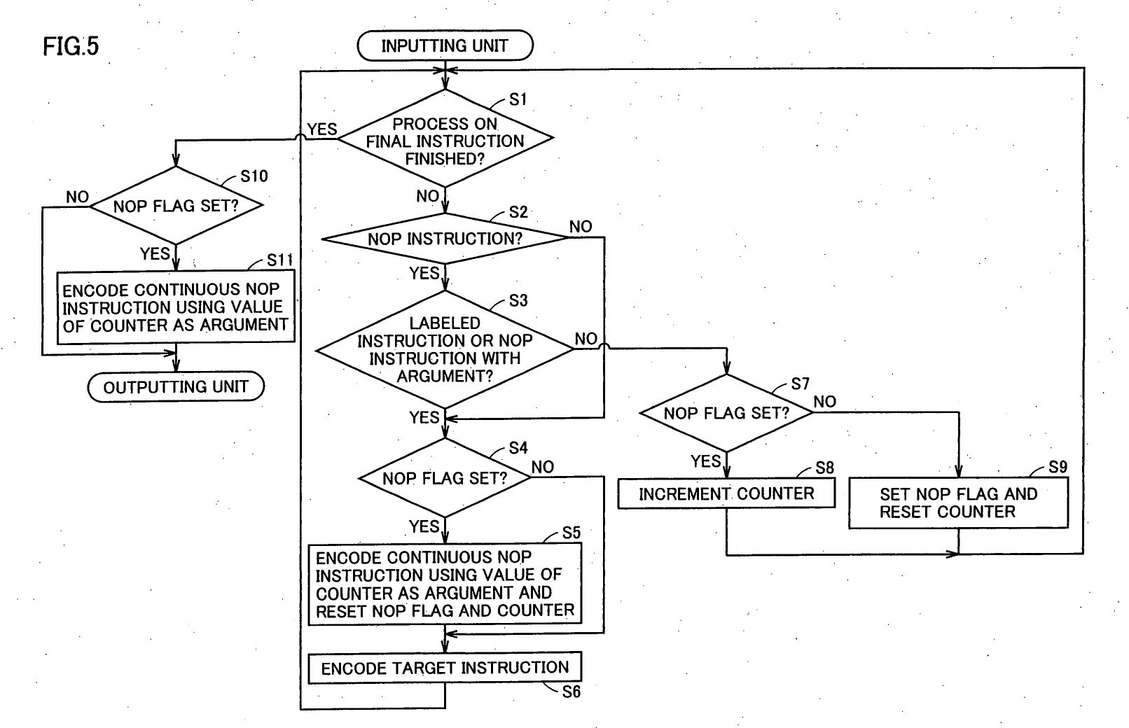

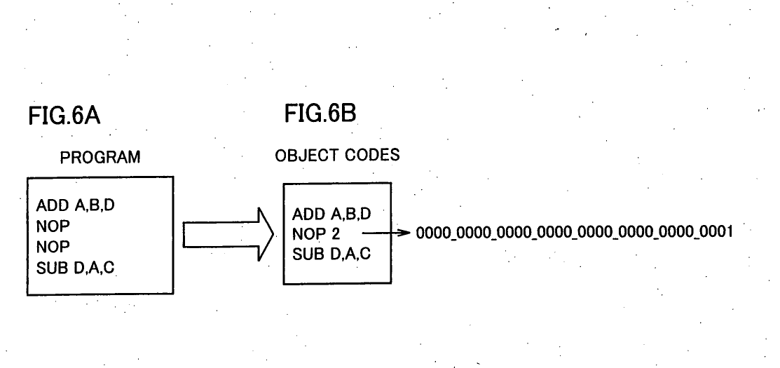

FIGS. 6A and 6B are diagrams showing an example of a program which is inputted to program inputting unit 12, and generated object codes. The way the program shown in FIG. 6A is assembled by assembler 11 will be described with reference to the flowchart of FIG. 5.

First, instruction analyzing unit 23 extracts an ADD instruction as the first instruction. The instruction is not a NOP instruction (No in S2) and no NOP flag is set (No in S4), so that instruction analyzing unit 23 encodes the ADD instruction (S6) and the processing returns to step S1.

Next, instruction analyzing unit 23 extracts a NOP instruction as the second instruction. The instruction is a NOP instruction (Yes in S2) and is neither a labeled NOP instruction nor a NOP instruction with an argument (No in S3), and no NOP flag is set (No in S7), so that NOP instruction analyzing part 24 sets a NOP flag and resets the counter to “0” (S9). The processing returns to step S1.

Instruction analyzing unit 23 extracts a NOP instruction as the third instruction. The instruction is a NOP instruction (Yes in S2) and is neither a labeled NOP instruction nor a NOP instruction with an argument (No in S3) and a NOP flag is set (Yes in S7), so that NOP instruction analyzing part 24 increments the counter (S8). The processing returns to step S1.

Instruction analyzing unit 23 extracts an SUB instruction as the fourth instruction. The instruction is not a NOP instruction (No in S2) and the NOP flag is set (Yes in S4), so that NOP instruction analyzing part 24 encodes a continuous NOP instruction (NOP2) using the value of the counter as an argument, and resets the NOP flag and the counter (S5). Instruction analyzing unit 23 encodes the SUB instruction as a target instruction (S6) and the processing returns to step S1.

Since the processing on the final instruction has been finished in step S1 (Yes in S1) and no NOP flag is set (No in S10), instruction code outputting unit 14 outputs the generated object code 15 and finishes the processing. FIG. 6B shows the object codes generated in such a manner.

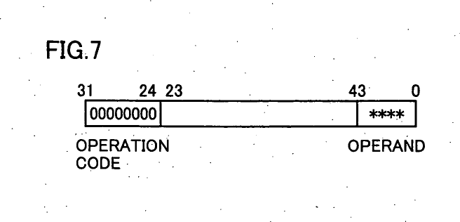

FIG. 7 is a diagram showing an example of the instruction code in the first embodiment of the present invention. Every instruction code of an instruction supported by the processor in the first embodiment of the present invention has a fixed length of 32 bits. As shown in FIG. 7, in the case where all of eight bits starting from the MSB (Most Significant Bit) of an instruction code as an operation code are zero, a continuous NOP instruction is specified. Four bits starting from the LSB (Least Significant Bit) are an operand designation field which is designated as an operand of the continuous NOP instruction. By the operand designation field, the number of NOP instructions inserted continuously is designated. Therefore, 16 NOP instructions can be designated at the maximum by the continuous NOP instruction. At the time of encoding the continuous NOP instruction in step S5 in FIG. 5, the value of the counter at that time is set in the operand designation field. The remaining 20 bits in the continuous NOP instruction is an undefined region.

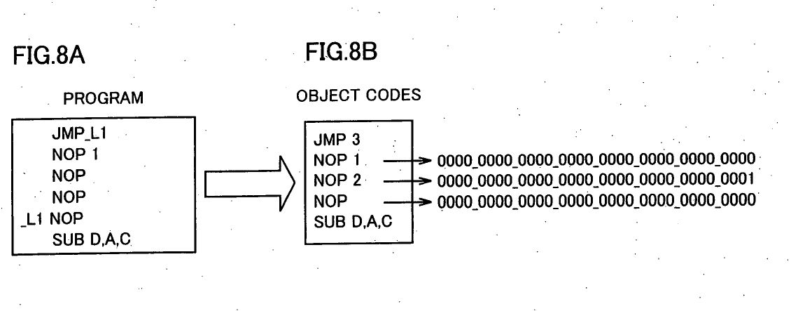

FIGS. 8A and 8B are diagrams showing an example of a program including a labeled NOP instruction and a NOP instruction with an argument, which is to be assembled by the assembler in the first embodiment of the present invention, and object codes of the program. The way the program shown in FIG. 8A is assembled by assembler 11 will be described with reference to the flowchart shown in FIG. 5.

First, instruction analyzing unit 23 extracts a JMP instruction as the first instruction. The instruction is not a NOP instruction (No in S2) and no NOP flag is set (No in S4), so that instruction analyzing unit 23 encodes the JMP instruction (S6) and the processing returns to step S1.

Next, instruction analyzing unit 23 extracts a NOP instruction as the second instruction. The instruction is a NOP instruction (Yes in S2) and is a NOP instruction with an argument (Yes in S3), and no NOP flag is set (No in S4), so that NOP instruction analyzing part 24 encodes a NOP instruction as a target instruction (S6). The processing returns to step S1.

Instruction analyzing unit 23 extracts a NOP instruction as the third instruction. The instruction is a NOP instruction (Yes in S2) and is neither a labeled NOP instruction nor a NOP instruction with an argument (No in S3) and no NOP flag is set (No in S7), so that NOP instruction analyzing part 24 sets a NOP flag and resets the counter to “0” (S9). The processing returns to step S1.

Instruction analyzing unit 23 extracts a NOP instruction as the fourth instruction. The instruction is a NOP instruction (Yes in S2) and is neither a labeled NOP instruction nor a NOP instruction with an argument (No in S3), and the NOP flag is set (Yes in S7), so that NOP instruction analyzing part 24 increments the value of the counter (S8). The processing returns to step S1.

Instruction analyzing unit 23 extracts a NOP instruction as the fifth instruction. The instruction is a NOP instruction (Yes in S2) and is a labeled NOP instruction (Yes in S3), and a NOP flag is set (Yes in S4), so that NOP instruction analyzing part 24 encodes a continuous NOP instruction (NOP2) using the value of the counter as an argument and resets the NOP flag and the counter (S5). NOP instruction analyzing part 24 encodes the NOP instruction as a target instruction (S6) and the processing returns to step S1.

Instruction analyzing unit 23 extracts an SUB instruction as the sixth instruction. The instruction is not a NOP instruction (No in S2) and no NOP flag is set (No in S4), so that instruction analyzing unit 23 encodes the SUB instruction as a target instruction (S6), and the processing returns to step S1.

Since the processing on the final instruction has been finished in step S1 (Yes in S1) and no NOP flag is set (No in S10), instruction code outputting unit 14 outputs object codes 15 generated and finishes the processing. FIG. 8B shows the object codes generated in such a manner.

As described above, the assembler in the embodiment encodes continuous NOP instructions into one instruction, so that the size of an object code can be reduced.

In the case where a target instruction is a labeled NOP instruction or a NOP instruction with an argument, instructions are not encoded into one instruction. Consequently, the assembler can be adapted also to the case where an address for storing an instruction has to be fixed, and an inconvenience such that an excessive NOP instruction is executed can be prevented.

Further, even a program generated by a conventional editor or the like can be also similarly assembled, so that the size of an object code can be reduced.

### Second Embodiment

A configuration example of an assembler in a second embodiment of the present invention is similar to that of the assembler in the first embodiment of the present invention shown in FIG. 3. A functional configuration of the assembler in the second embodiment of the present invention is similar to that of the assembler in the first embodiment of the present invention shown in FIG. 4. Therefore, detailed description of the same configurations and functions will not be repeated here.

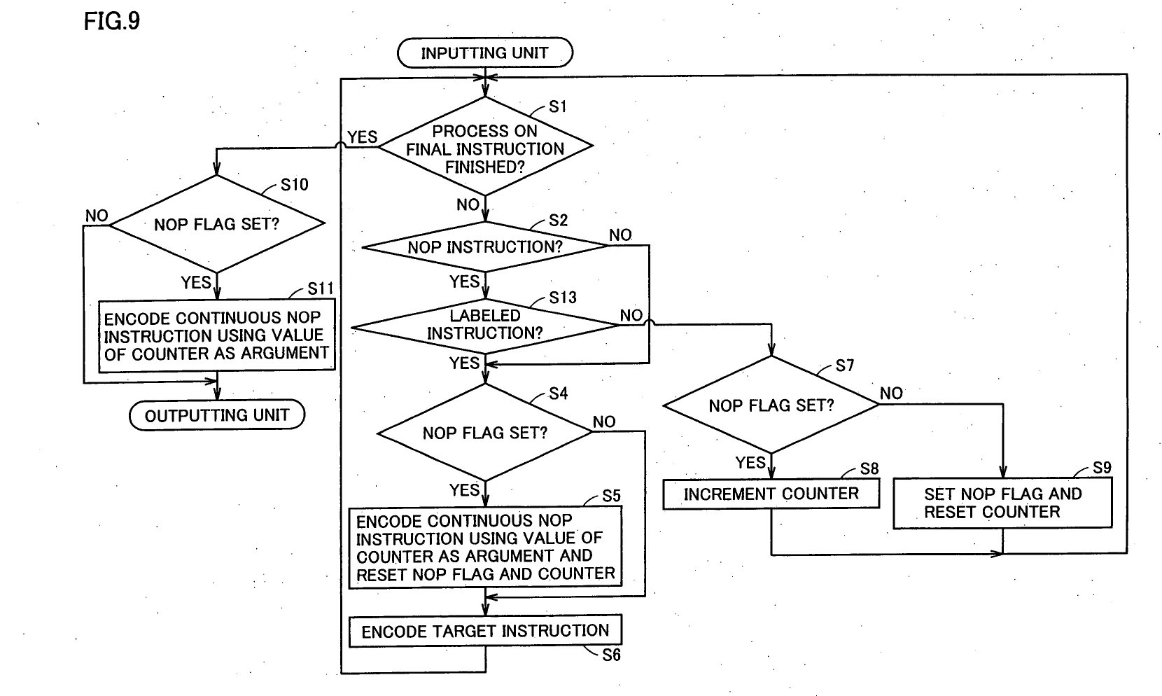

FIG. 9 is a flowchart for describing a procedure of the assembler in the second embodiment of the present invention. The procedure is different from that of the assembler in the first embodiment of the present invention shown in FIG. 5 only with respect to the point that step S3 is replaced with step S13. Therefore, detailed description of the same procedure will not be repeated here.

In step S13, NOP instruction analyzing part 24 determines whether the NOP instruction is a labeled NOP instruction or not (S13). If the instruction is a labeled NOP instruction (Yes in S13), NOP instruction analyzing part 24 determines whether a NOP flag is set or not (S4). If a NOP flag is set (Yes in S4), NOP instruction analyzing part 24 encodes a NOP instruction with an argument using the value of the counter as an argument and resets the NOP flag and the counter (S5). Instruction analyzing unit 23 encodes a target instruction (S6), returns to step S1, and repeats the following processes.

In the case where the NOP instruction is not a labeled NOP instruction (No in S13), instruction analyzing unit 23 determines whether a NOP flag is set or not (S7). If a NOP flag is set (Yes in S7), NOP instruction analyzing part 24 increments the value of the counter (S8), returns to step S1, and repeats the following processes.

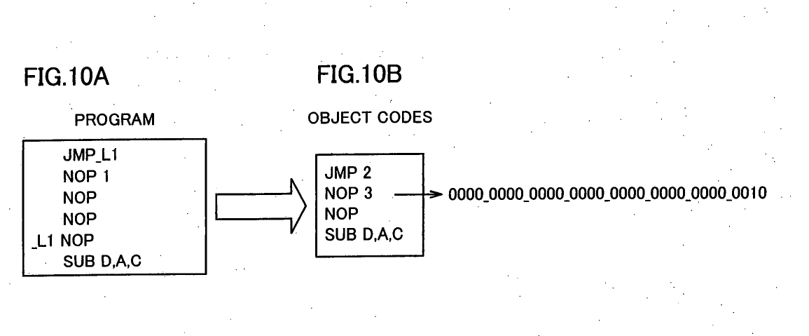

FIGS. 10A and 10B are diagrams showing an example of a program including a labeled NOP instruction and a NOP instruction with an argument, which is to be assembled by the assembler in the second embodiment of the present invention, and object codes of the program. The way the program shown in FIG. 10A is assembled by assembler 11 will be described with reference to the flowchart shown in FIG. 9.

First, instruction analyzing unit 23 extracts a JMP instruction as the first instruction. The instruction is not a NOP instruction (No in S2) and no NOP flag is set (No in S4), so that instruction analyzing unit 23 encodes the JMP instruction (S6) and the processing returns to step S1.

Next, instruction analyzing unit 23 extracts a NOP instruction as the second instruction. The instruction is a NOP instruction (Yes in S2) and is not a labeled NOP instruction (No in S13), and no NOP flag is set (No in S7), so that NOP instruction analyzing part 24 sets a NOP flag, and resets the counter to “0” (S9). The processing returns to step S1.

Instruction analyzing unit 23 extracts a NOP instruction as the third instruction. The instruction is a NOP instruction (Yes in S2) and is not a labeled NOP instruction (No in S13) and a NOP flag is set (Yes in S7), so that NOP instruction analyzing part 24 increments the value of the counter (S8). The processing returns to step S1.

Instruction analyzing unit 23 extracts a NOP instruction as the fourth instruction. The instruction is a NOP instruction (Yes in S2) and is not a labeled NOP instruction (No in S13), and a NOP flag is set (Yes in S7), so that NOP instruction analyzing part 24 increments the value of the counter (S8). The processing returns to step S1.

Instruction analyzing unit 23 extracts a NOP instruction as the fifth instruction. The instruction is a NOP instruction (Yes in S2) and is a labeled NOP instruction (Yes in S3), and a NOP flag is set (Yes in S4), so that NOP instruction analyzing part 24 encodes a continuous NOP instruction (NOP3) using the value of the counter as an argument and resets the NOP flag and the counter (S5). NOP instruction analyzing part 24 encodes the NOP instruction as a target instruction (S6) and the processing returns to step S1.

Instruction analyzing unit 23 extracts a SUB instruction as the sixth instruction. The instruction is not a NOP instruction (No in S2) and no NOP flag is set (No in S4), so that instruction analyzing unit 23 encodes the SUB instruction as a target instruction (S6), and the processing returns to step S1.

Since the processing on the final instruction has been finished in step S1 (Yes in S1) and no NOP flag is set (No in S10), instruction code outputting unit 14 outputs object codes 15 generated and finishes the processing. FIG. 10B shows the object codes generated in such a manner.

As described above, the assembler in the embodiment encodes a plurality of NOP instructions including a NOP instruction with an argument as a continuous NOP instruction in the case where it is not necessary to fix an address for storing an instruction. Consequently, in addition to the effect described in the first embodiment, the size of an object code can be further reduced.

### Third Embodiment

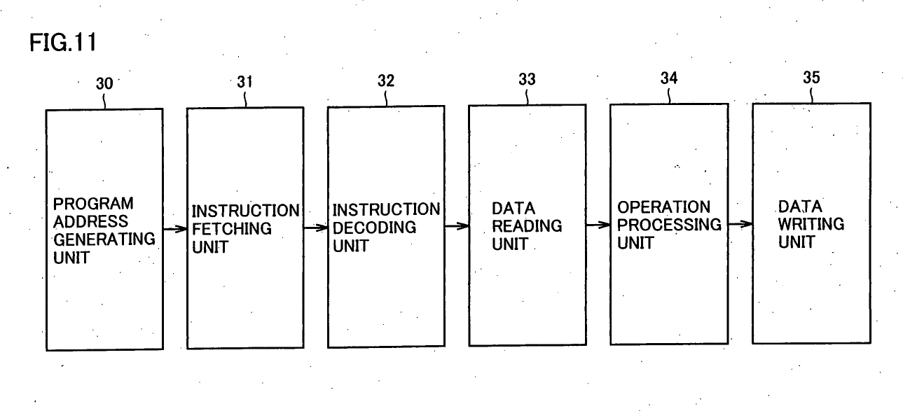

FIG. 11 is a block diagram showing a schematic configuration of a processor in a third embodiment of the present invention. The processor includes a program address generating unit 30 for generating an address of an instruction to be fetched, an instruction fetching unit 31 for fetching an instruction in accordance with the address generated by program address generating unit 30, an instruction decoding unit 32 for decoding the instruction fetched by instruction fetching unit 31, a data reading unit 33 for reading data from a memory or a register in accordance with a result of decoding by instruction decoding unit 32, an operation processing unit 34 for performing an integer arithmetic operation, a floating point arithmetic operation and the like by using the data read by data reading unit 33 as a source, and a data writing unit 35 for writing a result of the operation performed by operation processing unit 34 into a memory or a register.

Program address generating unit 30 generates a program address by using zero as an initial value and increments the program address every cycle in normal operation. In the case where a continuous NOP instruction flag is set, program address generating unit 30 does not update the program address. In the case where a branch condition is satisfied in a branch instruction, program address generating unit 30 sets a branch destination address as the program address.

Instruction fetching unit 31 fetches an instruction from an instruction memory (not-shown) in accordance with a program address generated by program address generating unit 30 and outputs the instruction to instruction decoding unit 32.

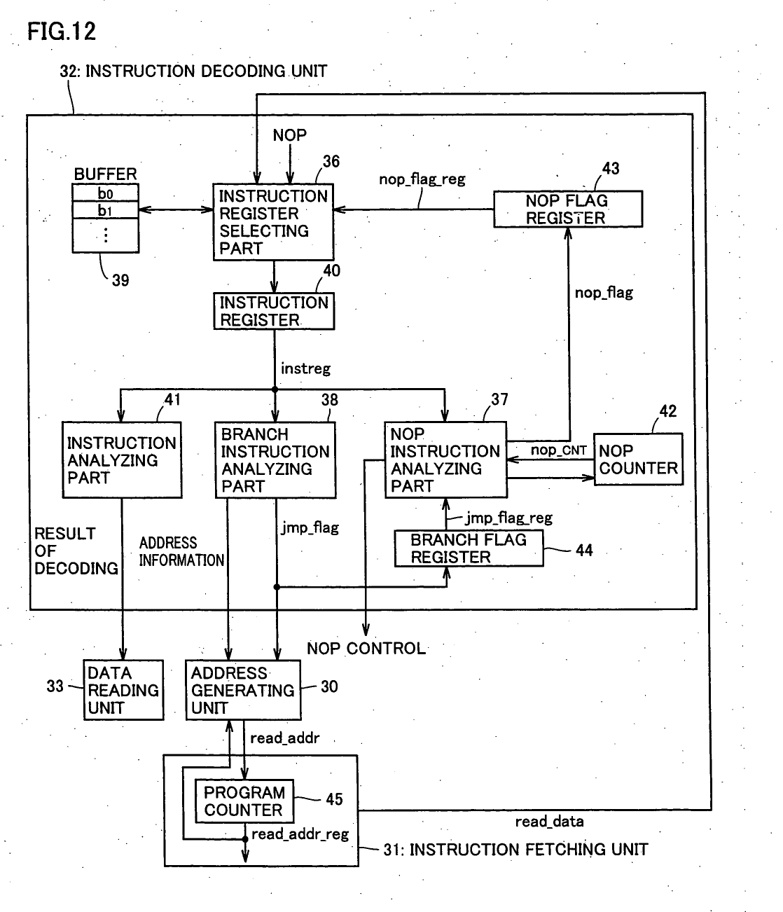

FIG. 12 is a block diagram for describing instruction decoding unit 32 shown in FIG. 11 in more detail. Instruction decoding unit 32 includes a buffer 39 for storing an instruction fetched by instruction fetching unit 31, an instruction register 40, an instruction register selecting part 36 for selecting either the instruction stored in buffer 39 or a NOP instruction and setting the selected one into instruction register 40, a NOP instruction analyzing part 37 for determining whether the instruction set in instruction register 40 is a continuous NOP instruction or not, a branch instruction analyzing part 38 for determining whether the instruction which is set in instruction register 40 is a branch instruction or not, an instruction analyzing part 41 for analyzing instructions other than the NOP instruction and the branch instruction and giving a result of decoding to data reading unit 33, a NOP counter 42 for counting NOP instructions which are continuously inserted, a NOP flag register 43 in which the continuous NOP instruction flag set by NOP instruction analyzing part 37 is stored, and a branch flag register 44 in which the branch instruction flag set by branch instruction analyzing part 38 is stored.

If the continuous NOP instruction flag is set in NOP flag register 43, instruction register selecting part 36 stores an instruction fetched by instruction fetching unit 31 into buffer 39 and stores a NOP instruction into instruction register 40. If the continuous NOP instruction flag is not set in NOP flag register 43, the instruction fetched by instruction fetching unit 31 is stored into instruction register 40.

NOP instruction analyzing part 37 decodes the NOP instruction (including the continuous NOP instruction) and performs a so-called. NOP control (no-operation control) on the respective units of the processor (including data reading unit 33 and address generating unit 30 which are shown in the figure).

NOP instruction analyzing part 37 determines whether the instruction stored in instruction register 40 by instruction register selecting part 36 is a continuous NOP instruction or not. In the case where the instruction in instruction register 40 is a continuous NOP instruction and no branch instruction flag is set in branch flag register 44, that is, in the case where the immediately preceding instruction is not a branch instruction, NOP instruction analyzing part 37 sets a continuous NOP instruction flag in NOP flag register 43. At this time, NOP instruction analyzing part 37 sets the value (N−1) in the operand designation field of the continuous NOP instruction designated as an argument (N) of the continuous NOP instruction as it is into NOP counter 42 and sets nop_flag.

In the assemblers of the first and second embodiments, in the case of resetting the initial value of the counter to “1” and writing (N) into the operand designation field of a continuous NOP instruction at the time of encoding N continuous NOP instructions into one continuous NOP instruction, it is possible to subtract one from the number of NOP execution times designated in the operand designation field in the continuous NOP instruction and set the resultant number into NOP counter 42.

When the continuous NOP instruction flag is set in NOP flag register 43 and the value of NOP counter 42 is not zero, NOP instruction analyzing part 37 reads and decodes the NOP instruction stored in instruction register 40. When a continuous NOP instruction flag is set in NOP flag register 43 and the value nop_cnt of NOP counter 42 is zero, NOP instruction analyzing part 37 resets the continuous NOP instruction flag to be stored in NOP flag register 43 and the instruction stored in buffer 39 is read and set in instruction register 40. In the other cases, that is, when jmp_flag_reg is set or the instruction in instruction register 40 is a normal NOP instruction which is not a continuous NOP instruction, NOP instruction analyzing part 37 leaves nop_flag in the reset state.

Branch instruction analyzing part 38 determines whether an instruction in instruction register 40 is a branch instruction or not and determines whether the instruction satisfies a branch condition or not. In the case where the instruction in instruction register 40 is a branch instruction and satisfies the branch condition, branch instruction analyzing part 38 sets jmp_flag and sets the value into branch flag register 44. In the case where the instruction in instruction register 40 is not a branch instruction or in the case where the instruction is a branch instruction but does not satisfy the branch condition, branch instruction analyzing part 38 resets jmp_flag, and sets the value into branch flag register 44. Also in the case where the instruction stored in instruction register 40 is an unconditional branch instruction, it is regarded that the instruction satisfies the branch condition, and jmp_flag is set.

Branch instruction analyzing part 38 outputs address information indicative of a branch destination address of the branch instruction. In the case where jmp_flag outputted from branch instruction analyzing part 38 is set, address generating unit 30 calculates the branch destination address on the basis of the address information and outputs it as read_addr.

Instruction fetching unit 31 has a program counter (PC), holds read_addr, and outputs it as read_addr_reg. When a branch by the branch instruction is not made, address generating unit 30 increments the value held in the PC and updates the data in the PC with the incremented value.

Instruction analyzing part 41 decodes instructions other than a branch instruction and the NOP instruction (including a continuous NOP instruction) and gives the result of decoding to data reading unit 33.

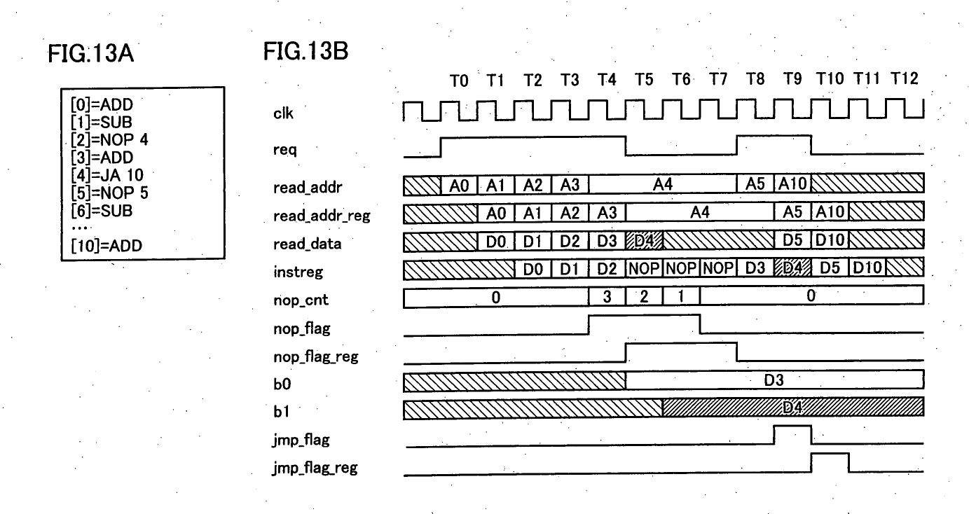

FIGS. 13A and 13B are diagrams showing an example of a program executed by a processor in a third embodiment of the present invention, and a timing chart. Referring to the program shown in FIG. 13A, the timing chart shown in FIG. 13B will be described.

In cycle TO, when a req signal of a high-level (H-level) is outputted, program address generating unit 30 outputs a program address A0 as a read_addr signal. The req signal is a signal which is outputted from instruction decoding unit 32 and, at the H level, instructs fetch of an instruction. When a continuous NOP instruction is executed, a req signal of a low-level (L level) is outputted.

In cycle T1, program address A0 is set in program counter 45 in instruction fetching unit 31 and is outputted as read_addr_reg. Instruction fetching unit 31 fetches an instruction D0 (ADD) corresponding to program address A0 and outputs it as read_data signal. In this cycle, program address generating unit 30 increments program counter 45 and outputs a program address A1 as the read_addr signal.

In cycle T2, since nop_flag_reg outputted from NOP flag register 43 is not set, instruction D0 is set in instruction register 40 and is outputted as instreg. Instruction analyzing part 41 decodes instruction D0. At this time, instruction fetching unit 31 fetches an instruction D1 (SUB) corresponding to a program address A1. Program address generating unit 30 outputs a program address A2 as read_addr.

In cycle T3, data reading unit 33 reads data corresponding to instruction D0. Instruction analyzing part 41 decodes instruction D1. At this time, instruction fetching unit 31 fetches an instruction D2 (NOP 4) corresponding to program address A2. Program address generating unit 30 outputs a program address A3 as the read_addr signal.

In cycle T4, operation processing unit 34 performs an operation according to instruction D0 (ADD). Since a continuous NOP instruction flag is not set in NOP flag register 43, instruction register selecting part 36 sets instruction D2 (NOP 4) in instruction register 40. Since instruction D2 is a continuous NOP instruction, NOP instruction analyzing part 37 sets nop_flag, sets a continuous NOP instruction flag in NOP flag register 43, and sets 3(4-1) in NOP counter 43. Since a branch instruction is not stored in instruction register 40, a branch instruction flag is not set in branch flag register 44. Instruction fetching unit 31 fetches an instruction D3 (ADD) corresponding to program address A3. Program address generating unit 30 outputs a program address A4 as the read_addr signal.

In cycle T5, since the continuous NOP instruction flag is set in NOP flag register 43, instruction register selecting part 36 sets a NOP instruction in instruction register 40. Instruction D3 fetched by instruction fetching unit 31 is held as b0 in buffer 39. Since a continuous NOP instruction flag is set, NOP instruction analyzing part 37 decrements the value of NOP counter 42 (nop_cnt=2).

In cycle T6, since the continuous NOP instruction flag is set in NOP flag register 43, instruction register selecting part 36 sets a NOP instruction in instruction register 40. An instruction D4 (JA 10) fetched by instruction fetching-unit 31 is held as b1 in buffer 39. Since the continuous NOP instruction flag is set in NOP flag register 43, NOP instruction analyzing part 37 decrements the value of NOP counter 42 (nop_cnt=1).

In cycle T7, since the continuous NOP instruction flag is set in NOP flag register 43, instruction register selecting part 36 sets a NOP instruction in instruction register 40. Since the continuous NOP instruction flag is set in NOP flag register 43, NOP instruction analyzing part 37 decrements the value of NOP counter 42 (nop_cnt=0). At this time, the value of NOP counter 42 becomes 0, so that NOP instruction analyzing part 37 resets the continuous NOP instruction flag to be stored in NOP flag register 43.

In cycle T8, since the value of NOP counter 42 is 0, instruction register selecting part 36 sets instruction D3 which is held as b0 in buffer 39 into instruction register 40. Since the instruction set in instruction register 40 is not a NOP instruction, NOP instruction analyzing part 37 leaves the continuous NOP instruction flag to be stored in NOP flag register 43. Since the req signal becomes the H level again, program address generating unit 30 increments the program address and outputs address A5 as the read_addr signal.

In cycle T9, instruction decoding unit 32 decodes instruction D4. Since instruction D4 (JA 10) is a branch instruction of unconditionally making a branch to address 10, branch instruction analyzing part 38 sets a branch instruction flag in branch flag register 44. Program address generating unit 30 outputs a branch destination address A10 as the read_addr signal.

In cycle T10, since the continuous NOP instruction flag is not set in NOP flag register 43, instruction register selecting part 36 sets D5 (NOP 5) in instruction register 40. Instruction D5 is a continuous NOP instruction but the branch instruction flag is set in branch flag register 44, so that NOP instruction analyzing part 37 does not set a continuous NOP instruction flag in NOP flag register 43. Instruction fetching unit 31 fetches an instruction D10 (ADD) corresponding to address A10.

In cycle T11, since a continuous NOP instruction flag is not set in NOP flag register 43, instruction register selecting part 36 sets an instruction D10 in instruction register 40. Instruction analyzing part 41 decodes instruction D10.

Although one NOP which does not depend on “NOP 5” is inserted in correspondence with the fact that the branch condition of “JA 10” is satisfied in cycle T10, two or more NOPs may be inserted in accordance with an instruction fetch cycle.

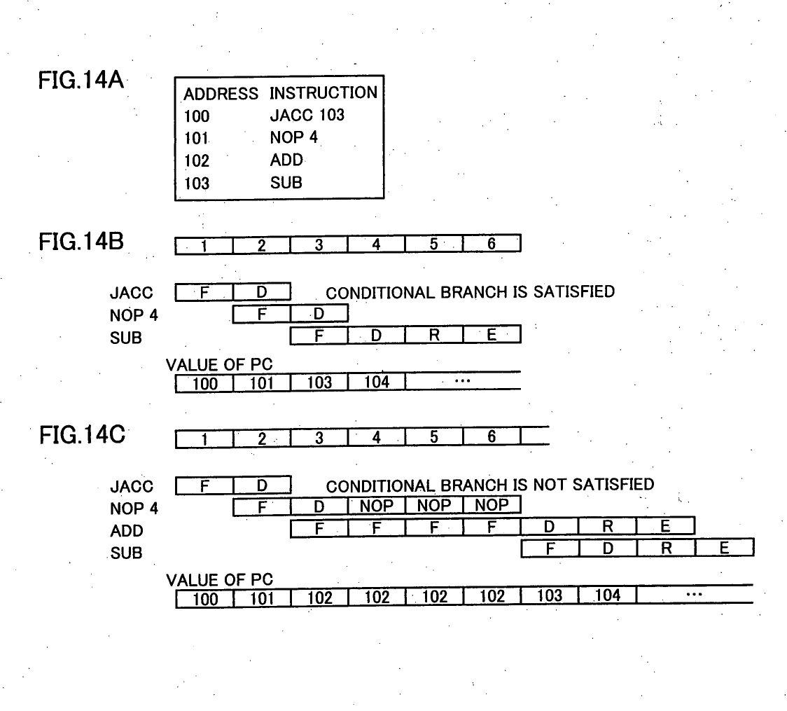

FIG. 14A is a diagram showing an example of a program including a conditional branch instruction JACC to be executed by the processor in the third embodiment of the present invention. A conditional branch instruction “JACC 103” is an instruction of making a branch to an instruction of address 103 as a designated destination when a branch condition is satisfied and, when the branch condition is not satisfied, shifting to a process of the following instruction of address 101 without branching the instruction.

FIG. 14B is a diagram for describing a pipeline process in the case where the branch condition is satisfied. In cycle 1, a conditional branch instruction “JACC 103” is fetched.

In cycle 2, the JACC instruction is decoded, and the next instruction “NOP 4” is fetched. At this decoding stage of the JACC instruction, it is determined whether a branch condition is satisfied or not.

In cycle 3, since the branch condition is satisfied, “NOP 4” is decoded, and an SUB instruction of address 103 as a branch destination is fetched.

In cycle 4, the SUB instruction is decoded. In the subsequent cycles, processing on the SUB instruction and following instructions is performed.

FIG. 14C is a diagram for describing a pipeline process performed in the case where the branch condition is not satisfied. Up to and including cycle 2, the process is similar to that shown in FIG. 14B. Since the branch condition is not satisfied in cycle 3, an “NOP 4” instruction is decoded.

In cycles 4 to 6, three NOPs are inserted. In cycle 6, the following AND instruction is fetched. In the following cycles, processing on the ADD instruction and following instructions is performed.

As described above, in the processor of the third embodiment, instruction fetching unit 31 does not access an instruction memory during processing of the continuous NOP instruction, so that consumption power can be reduced. Since a plurality of NOP instructions are encoded to one continuous NOP instruction, when a cache memory is used as the instruction memory, a cache hit rate can be improved.

Generally, at the time of execution of the conditional branch instruction, the process in the case where the branch condition is satisfied and that in the case where the branch condition is not satisfied are different from each other, so that resource conflicts, conditions and the like are also different from each other. In the embodiment, when the condition is not satisfied (when no branch is made), a continuous NOP instruction immediately after the branch instruction is regarded as an instruction specifying the number of necessary NOPs. When the condition is satisfied (when branch is made), the continuous NOP instruction immediately after the branch instruction is processed as a normal NOP instruction. Thus, insertion of an unnecessary NOP can be prevented at the time of executing the conditional branch instruction.

### Fourth Embodiment

In the third embodiment of the present invention, as shown in FIG. 13B, instructions of the number of cycles between a branch instruction fetch stage and a decode stage are processed during the period since a branch instruction is fetched and until branch is actually made to a branch destination address. Generally, those instructions are often replaced with NOP instructions. Therefore, a NOP instruction has to be always inserted after a branch instruction, so that the size of an object code increases. A fourth embodiment relates to a processor for executing a branch instruction with NOP including NOP instructions of the number corresponding to the number of necessary NOP execution times.

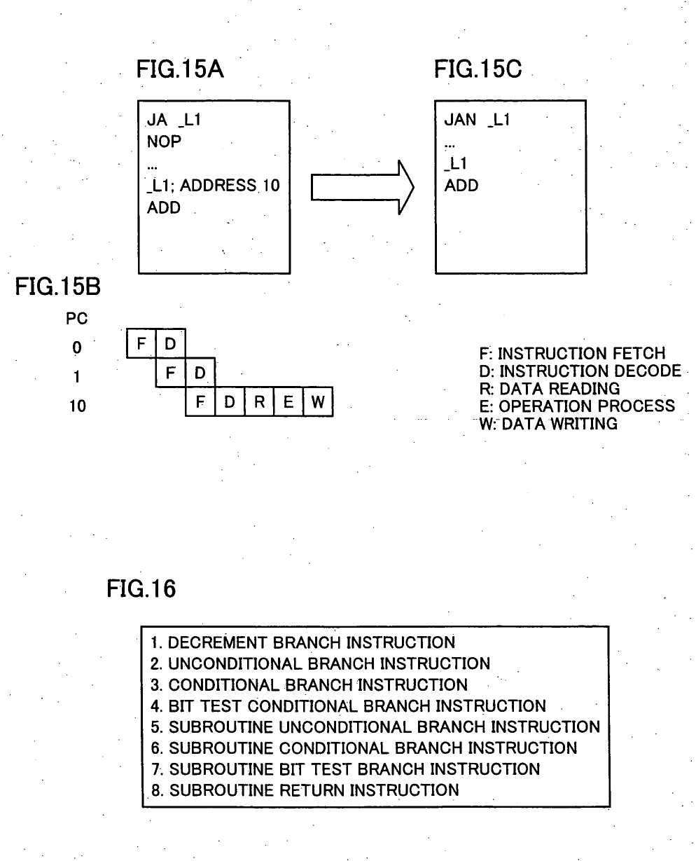

FIGS. 15A to 15C are diagrams for describing processes executed by a processor in the fourth embodiment of the present invention. FIG. 15A is a diagram showing an example of a program of the case where a NOP instruction is inserted after a JA instruction.

FIG. 15B is a diagram showing a pipeline process performed when the program illustrated in FIG. 15A is executed. First, an instruction (JA) in address 0 is fetched. In the following cycle, the JA instruction is decoded and an instruction (NOP) in address 1 is fetched. Further, in the following cycle, the NOP instruction is decoded, and an instruction (ADD) in address 10 as a branch destination is fetched.

FIG. 15C is a diagram showing an example of a program of the case where the JA instruction shown in FIG. 15A and a NOP instruction subsequent to the JA instruction are replaced with a JAN instruction as a branch instruction with NOP. By replacing the JA instruction and the NOP instruction with the branch instruction with NOP (JAN), the size of the object code can be reduced.

FIG. 16 is a diagram for describing kinds of the branch instruction with NOP. It is assumed that a branch instruction with a NOP instruction is supported with respect to all of the instructions and, in the case where it is unnecessary to insert a NOP instruction after a branch instruction, a normal branch instruction which includes no NOP instruction is also supported.

In FIG. 16, a decrement branch instruction is an instruction of decrementing a preset value of a loop counter each time an instruction is executed and, when the value of the loop counter becomes 0, making branch to a designated address.

An unconditional branch instruction is an instruction of unconditionally executing branch to a designated address. A conditional branch instruction is an instruction of executing branch to a designated address in the case where a conditional expression designated on the basis of an arithmetic operation result or the like is satisfied.

A bit test condition branch instruction is an instruction of executing branch to a designated address in the case where a designated specific bit of the value of a certain register is 0 or 1. Either 0 or 1 can be designated as a true.

A subroutine unconditional branch instruction is an instruction of unconditionally executing branch to a designated address and returning to an address immediately after the branch by a subroutine return instruction.

A subroutine conditional branch instruction is an instruction of executing branch to a designated address in the case where a conditional expression designated on the basis of a result of arithmetic operation or the like is satisfied and returning to an instruction immediately after the branch by a subroutine return instruction.

A subroutine bit test conditional branch instruction is an instruction of executing branch to a designated address when a bit test is carried out and a condition is satisfied and returning to an address immediately after the branch by a subroutine return instruction.

A subroutine return instruction is an instruction of returning to an address immediately after the subroutine instruction executed just before.

A schematic configuration of the processor in the fourth embodiment of the present invention is different from that of the processor in the third embodiment shown in FIG. 11 only with respect to the point that the configuration of an instruction decoding unit differs. Therefore, the detailed description of the same configurations and functions will not be repeated here. Reference numeral 52 is given to an instruction decoding unit in the fourth embodiment.

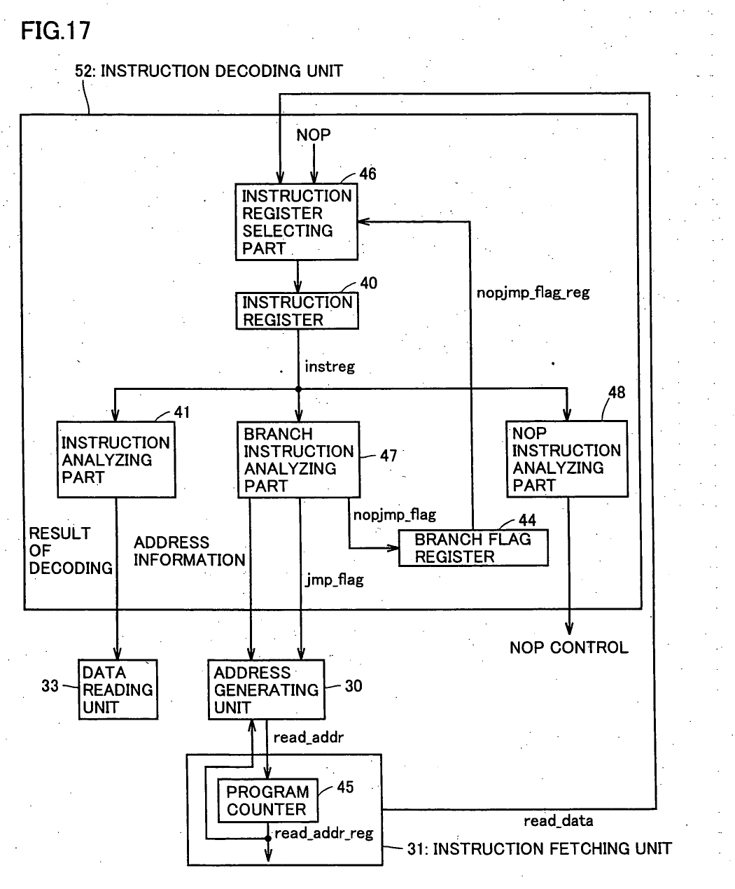

FIG. 17 is a block diagram for describing the details of instruction decoding unit 52. Instruction decoding unit 52 includes instruction register 40, instruction analyzing part 41, branch flag register 44, an instruction register selecting part 46, a branch instruction analyzing part 47, and a NOP instruction analyzing part 48. The same reference numerals are given to parts having functions similar to those of instruction decoding unit 32 shown in FIG. 12.

Branch instruction analyzing part 47 analyzes the branch instruction shown in FIG. 16 irrespective of whether the instruction is provided with a NOP or not. Branch instruction analyzing part 47 sets jmp_flag in the case where an instruction to be stored in instruction register 40 is a branch instruction and a branch condition is satisfied irrespective of whether the branch instruction is provided with a NOP or not. Branch instruction analyzing part 47 resets jmp_flag in other cases.

Particularly, in the case where an instruction to be stored in instruction register 40 is a branch instruction with a NOP and a branch condition is satisfied, branch instruction analyzing part 47 sets nopjmp_flag and sets it in branch flag register 44. In other cases, branch instruction analyzing part 47 resets nopjmp_flag and sets it in branch flag register 44.

If nopjmp_flag reg outputted from branch flag register 44 is set, instruction register selecting part 46 stores a NOP instruction in instruction register 40. If nopjmp_flag_reg outputted from branch flag register 44 is reset, instruction register selecting part 46 stores an instruction fetched by instruction fetching unit 31 into instruction register 40.

NOP instruction analyzing part 48 outputs an instruction for performing a NOP control to each of the components of the processor when an instruction stored in instruction register 40 is a NOP instruction.

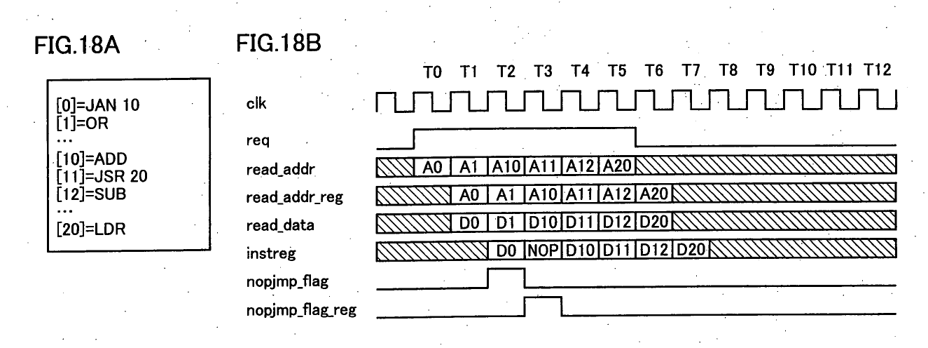

FIGS. 18A and 18B are diagrams showing an example of a program executed by the processor in the fourth embodiment of the present invention, and a timing chart at the time of the execution. With reference to the program shown in FIG. 18A, the timing chart shown in FIG. 18B will be described below.

In cycle T0, when a req signal of the H level is outputted, program address generating unit 30 outputs a program address A0 as a read_addr signal.

In cycle T1, program address A0 is set in program counter 45, instruction fetching unit 31 fetches an instruction D0 (JAN) corresponding to program address A0 and outputs it as a read_data signal. In this cycle, program address generating unit 30 increments the program address and outputs a program address A1 as the read_addr signal.

In cycle T2, since a nopjmp_flag_reg signal which is outputted from branch flag register 44 is not set, an instruction D0 is set in instruction register 40. Branch instruction analyzing part 47 decodes instruction D0. Since, instruction D0 is a branch instruction with NOP and unconditional branch instruction, branch instruction analyzing part 47 sets nopjmp_flag. At this time, instruction fetching unit 31 fetches an instruction D1 (OR) corresponding to a program address A1. Program address generating unit 30 outputs a branch destination address A10 as a read_addr signal. “JAN 10” denotes an unconditional branch instruction with NOP to address 10.

In cycle T3, since nopjmp_flag_reg outputted from branch flag register 44 is set, instruction register selecting part 46 sets a NOP instruction in instruction register 40. Branch instruction analyzing part 47 resets nopjmp_flag since the data in instruction register 40 is not a branch instruction with NOP.

In cycle T4, instruction analyzing part 41 decodes an instruction D10 (ADD) corresponding to program address A10. Instruction fetching unit 31 fetches an instruction D11 (JSR 20) corresponding to program address A11. “JSR 20” indicates a subroutine unconditional branch instruction.

In cycle T5, branch instruction analyzing part 47 decodes instruction D11 corresponding to program address A11. Instruction fetching unit 31 fetches an instruction D12 (SUB) corresponding to a program address A12.

In cycle T6, instruction analyzing part 41 decodes an instruction D12 corresponding to a program address A12. Instruction fetching unit 31 fetches an instruction D20 (LDR) corresponding to A20 as a branch destination address. “LDR” denotes an instruction of loading data to a register.

In cycle T7, instruction analyzing part 41 decodes an instruction D20 corresponding to program address A20.

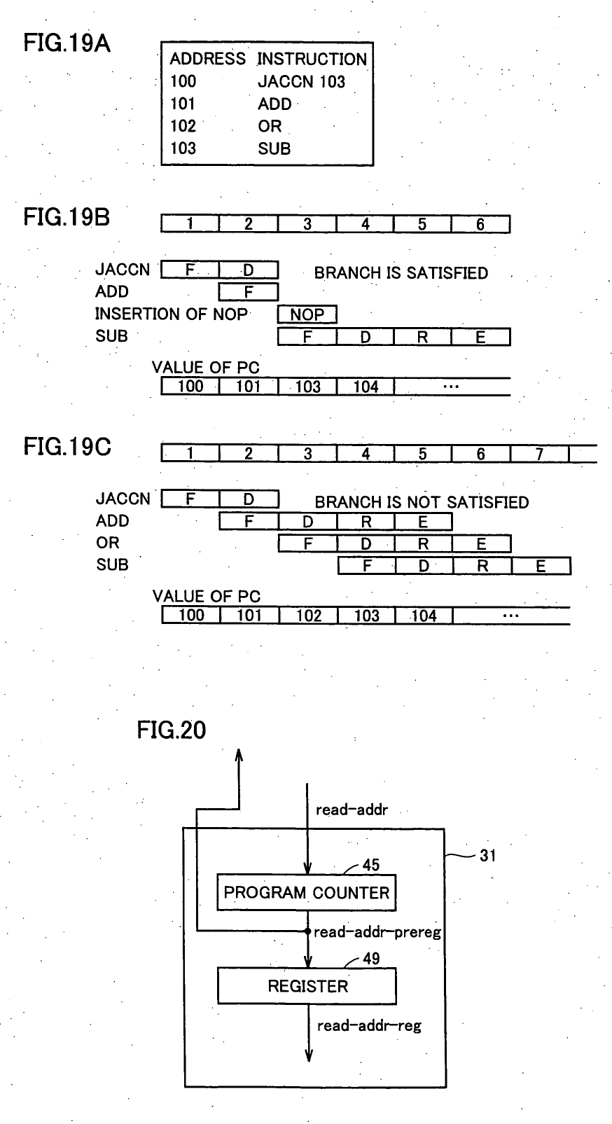

FIG. 19A is a diagram showing an example of a program including a conditional branch instruction JACCN with NOP executed by the processor in the fourth embodiment of the present invention. Conditional branch instruction “JACCN 103” with NOP is an instruction of executing branch to address 103 as a designated destination when a branch condition is satisfied and, when the branch condition is not satisfied, shifting to a process on the next instruction of address 101 without performing branch.

FIG. 19B is a diagram for describing a pipeline process performed in the case where the branch condition is satisfied. In cycle 1, a conditional branch instruction “JACCN 103” with NOP is fetched.

In cycle 2, a JACCN instruction is decoded and the following ADD instruction is fetched. At the stage of decoding the JACCN instruction, it is determined whether the branch condition is satisfied or not.

In cycle 3, since the branch condition is satisfied, an ADD decoding stage is canceled and, instead, a decoding stage of NOP instruction is inserted. In the cycle, the SUB instruction in address 103 as a branch destination is fetched.

In cycle 4, the SUB instruction is decoded. In the subsequent cycles, process on the SUB instruction and subsequent instructions is performed.

FIG. 19C is a diagram for describing a pipeline process performed in the case where the branch condition is not satisfied. Up to and including cycle 2, the process is similar to that shown in FIG. 19B. In cycle 3, since the branch condition is not satisfied, the ADD instruction is decoded. In this cycle, an OR instruction in the following address 102 is fetched.

In cycle 4, an operand of the ADD instruction is read, the OR instruction is decoded, and the SUB instruction is fetched. In the following cycles, the instructions are processed. “OR” denotes an OR logic operation instruction.

As described above, the processor of the embodiment supports the branch instruction with NOP, so that the size of an object code can be reduced.

Since instruction fetching unit 31 does not access an instruction memory during process on a NOP instruction added to a branch instruction, power consumption can be reduced. Since a NOP instruction is encoded in a branch instruction with NOP, in the case of using the instruction memory as a cache memory, cache hit rate can be improved.

### Fifth Embodiment

A schematic configuration of a processor in a fifth embodiment of the present invention is different from that of the processor in the third embodiment shown in FIG. 11 only with respect to the point in that the configuration of the instruction fetching unit is different. The configuration of an instruction decoding unit in the fifth embodiment of the present invention is similar to that of the instruction decoding unit in the fourth embodiment shown in FIG. 17. The detailed description of the same configurations and functions will not be repeated.

FIG. 20 is a block diagram showing the configuration of the instruction fetching unit in the fifth embodiment of the present invention. Instruction fetching unit 31 includes a program counter 45 and a register 49. Register 49 delays read_addr_prereg outputted from program counter 45 only by one clock and outputs the resultant signal as read_addr_reg.

In the processor of the fifth embodiment, when a branch instruction with NOP is set in instruction register 40 and a branch condition is satisfied, branch instruction analyzing part 47 sets nopjmp_flag and sets the number of fetch cycles as a value of a counter. It is assumed that the number of fetch cycles is preset.

If jmp_flag_reg outputted from branch instruction flag register 44 is set, branch instruction analyzing part 47 decrements the value of the counter in accordance with the cycle and sets nopjmp_flag until the value of the counter becomes 0. When the value of the counter becomes 0, branch instruction analyzing part 47 resets nopjmp_flag. By the operation, even in the case where the number of fetch cycles is larger than 1, necessary NOP is inserted.

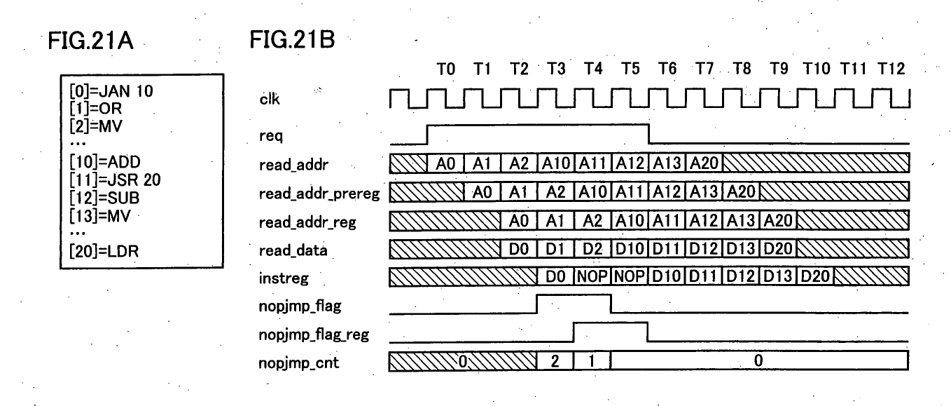

FIGS. 21A and 21B are diagrams showing an example of a program executed by the processor in the fifth embodiment of the present invention, and a timing chart. With reference to the program shown in FIG. 21A, the timing chart shown in FIG. 21B will be described below.

In cycle T0, when a req signal of the H level is outputted, program address generating unit 30 outputs a program address A0 as a read_addr signal.

In cycle T1, program address A0 is set in program counter 45 in instruction fetching unit 31.

In cycle T2, register 49 in instruction fetching unit 31 outputs program address A0 as read_addr_reg, and instruction fetching unit 31 fetches an instruction D0 (JAN) corresponding to program address A0 via the read_data signal.

In cycle T3, since nopjmp_flag_reg is not set in branch instruction flag register 44, instruction D0 is set in instruction register 40. Branch instruction analyzing part 47 decodes instruction D0. Instruction D0 is a branch instruction with NOP and an unconditional branch instruction, so that branch instruction analyzing part 47 sets nopjmp_flag_reg and sets 2 in the counter. At this time, program address generating unit 30 outputs a branch destination address A10 as a read_addr signal.

In cycle T4, since nopjmp_flag_reg outputted from branch flag register 44 is set, instruction register selecting part 46 sets a NOP instruction in the instruction register. Since the value of the counter is not 0, branch instruction analyzing part 47 decrements the value of the counter.

In cycle 5, since nopjmp_flag_reg outputted from branch flag register 44 is set, instruction register selecting part 46 sets a NOP instruction in instruction register 40. Branch instruction analyzing part 47 resets nopjmp_flag since the value of the counter is 0.

In cycle T6, instruction analyzing part 41 decodes an instruction D10 (ADD) corresponding to a program address A10. Instruction fetching unit 31 fetches an instruction D11 (JSR 20) corresponding to program address A11.

In cycle T7, branch instruction analyzing part 47 decodes an instruction D11 corresponding to program address A11. Instruction fetching unit 31 fetches an instruction D12 (SUB) corresponding to a program address A12.

In cycle T8, instruction analyzing part 41 decodes an instruction D12 corresponding to program address A12. Instruction fetching unit 31 fetches an instruction D13 (MV) corresponding to a program address A13. MV denotes a data transfer instruction.

In cycle T9, instruction analyzing part 41 decodes an instruction D13 corresponding to a program address A13. Instruction fetching unit 31 fetches an instruction D20 (LDR) corresponding to a branch destination address A20.

In cycle T10, instruction analyzing part 41 decodes instruction D20 corresponding to program address A20.

As described above, the processor of the embodiment supports a branch instruction with NOP including a plurality of NOP instructions, so that the size of an object code can be further reduced.

Since instruction fetching unit 31 does not access an instruction memory during process on a plurality of NOP instructions added to a branch instruction, consumption power can be reduced. Since a NOP instruction is encoded in a branch instruction with NOP, in the case of using the instruction memory as a cache memory, the cache hit rate can be improved.

Further, also in the case of executing the branch instruction with NOP, a program counter is updated in a manner similar to the case of a normal instruction. Consequently, even in the case where a branch condition is not satisfied, an instruction immediately after the branch instruction can be executed without delay.

### Sixth Embodiment

A schematic configuration of a processor in a sixth embodiment of the present invention is similar to that of the processor in the third embodiment shown in FIG. 11 except for the configuration of the instruction decoding unit. The detailed description of the same configurations and functions will not be repeated here. Reference numeral 53 is given to an instruction decoding unit in the sixth embodiment.

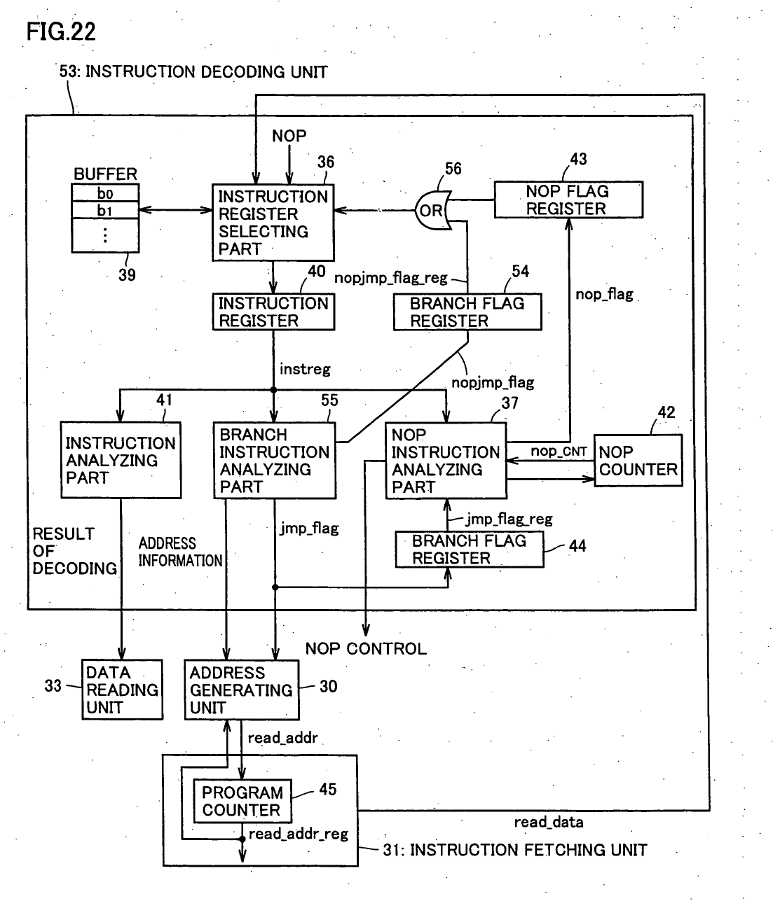

FIG. 22 is a block diagram for describing the details of instruction decoding unit 53. Instruction decoding unit 53 includes instruction register selecting part 36, NOP instruction analyzing part 37, buffer 39, instruction register 40, instruction analyzing part 41, NOP counter 42, NOP flag register 43, branch flag registers 44 and 54, a branch instruction analyzing part 55, and an OR circuit 56. The same reference numerals are given to parts having functions similar to those of instruction decoding unit 32 shown in FIG. 12.

Branch instruction analyzing part 53 determines whether data in instruction register 40 is a branch instruction or not. In the case where the data in instruction register 40 is a branch instruction, branch instruction analyzing part 55 sets jmp_flag and sets the value into branch flag register 44. In the case where data in instruction register 40 is not a branch instruction, branch instruction analyzing part 55 resets jmp_flag and sets the value into branch flag register 44.

Branch instruction analyzing part 55 sets nopjmp_flag in the case where an instruction to be stored in instruction register 40 is a branch instruction with NOP and a branch condition is satisfied, and sets the value into branch flag register 54. In other cases, branch instruction analyzing part 55 resets nopjmp_flag and sets the value into branch flag register 54.

OR circuit 56 calculates a logical OR of values outputted from NOP flag register 43 and branch flag register 54 and outputs the computation result to instruction register selecting part 36.

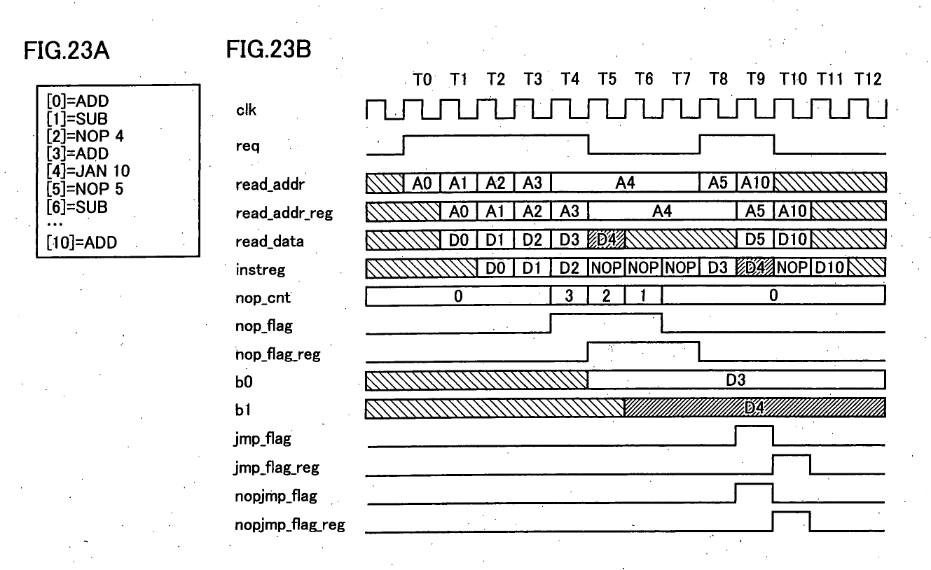

FIGS. 23A and 23B are diagrams showing an example of a program executed by the processor in the sixth embodiment of the present invention, and a timing chart. With reference to the program shown in FIG. 23A, the timing chart shown in FIG. 23B will be described below. The operations in cycles T0 to T8 are similar to those in the timing chart of the processor of the third embodiment shown in FIG. 13B. Therefore, description of the same operations will not be repeated.

In cycle T9, branch instruction analyzing part 55 decodes an instruction D4. Instruction D4 is a branch instruction, so that branch instruction analyzing part 55 sets jmp_flag. Since instruction D4 is a branch instruction with NOP, branch instruction analyzing part 55 sets nopjmp_flag. Program address generating unit 30 outputs branch destination address A10 as the read_addr signal.

In cycle T10, since an H-level signal is outputted from OR circuit 56, instruction register selecting part 36 sets NOP in instruction register 40. Since NOP is set in instruction register 40, jmp_flag and nopjmp_flag are reset. Instruction fetching unit 31 fetches an instruction D10 (ADD) corresponding to address A10.

In cycle T11, since an L-level signal is outputted from OR circuit 56, instruction register selecting part 36 sets instruction D10 in instruction register 40. Instruction analyzing part 41 decodes instruction D10.

As described above, in the processor of the embodiment, instruction fetching unit 31 does not access an instruction memory during process on a continuous NOP instruction or a NOP instruction added to a branch instruction with NOP, so that power consumption can be reduced. Since NOP instructions are encoded as one continuous NOP instruction or branch instruction with NOP, in the case of using the instruction memory as a cache memory, the cache hit rate can be improved.

In the case where a condition is satisfied (in the case of performing branch), a continuous NOP instruction immediately after the branch instruction is processed as a normal NOP instruction. Thus, insertion of unnecessary NOP at the time executing a conditional branch instruction can be prevented.

Further, in the case of executing a branch instruction with NOP, a program counter is updated in a manner similar to the case of a normal instruction. Consequently, also in the case where a branch condition is not satisfied, an instruction immediately after the branch instruction is executed without delay.

Although the present invention has been described and illustrated in detail, it is clearly understood that the same is by way of illustration and example only and is not to be taken by way of limitation, the spirit and scope of the present invention being limited only by the terms of the appended claims.

1. An assembler comprising:
an instruction analyzing unit sequentially analyzing instructions of an inputted program and encoding a plurality of continuous no-operation instructions as a continuous no-operation instruction having an operand designating the number of the plurality of no-operation instructions; and
an outputting unit outputting the instruction encoded by said instruction analyzing unit as an object code.

2. The assembler according to claim 1, wherein
when an instruction is a labeled no-operation instruction, said instruction analyzing unit encodes the instruction so as not to be included in said continuous no-operation instruction.

3. The assembler according to claim 1, wherein
when an instruction is a no-operation instruction with an argument for performing no-operations of the number corresponding to the argument, said instruction analyzing unit encodes the instruction so as not to be included in said continuous no-operation instruction.

4. A processor comprising:
an address generating unit generating an address of an instruction to be fetched;
an instruction fetching unit fetching an instruction in accordance with the address generated by said address generating unit;
an instruction decoding unit decoding the instruction fetched by said instruction fetching unit; and
an instruction executing unit executing the instruction in accordance with a result of decoding of said instruction decoding unit, wherein
when an instruction to be decoded is a continuous no-operation instruction having an operand designation field, said instruction decoding unit can process the instruction as continuous no-operation instructions of the number corresponding to the number designated in the operand designation field, and
when the instruction fetched immediately before the continuous no-operation instruction is a branch instruction and branch is performed by the branch instruction, said instruction decoding unit processes the instruction as no-operation instructions of the number which does not depend on said operand designation field.

5. A processor comprising:
an address generating unit generating an address of an instruction to be fetched;
an instruction fetching unit fetching an instruction in accordance with the address generated by said address generating unit;
an instruction decoding unit decoding the instruction fetched by said instruction fetching unit; and
an instruction executing unit executing the instruction in accordance with a result of decoding of said instruction decoding unit, wherein
when the decoded instruction is a branch instruction with no-operation and a branch condition is satisfied, said instruction decoding unit inserts a no-operation instruction after the branch instruction with no-operation and, when the decoded instruction is a branch instruction with no operation and a branch condition is not satisfied, said instruction decoding unit does not insert a no-operation instruction.
